(19) United States
(12) Patent Application Publication
(10) Pub. No.: US 2025/0232559 A1
(43) Pub. Date: Jul. 17, 2025

(54) METHOD AND SYSTEM FOR TEXTURE IDENTIFICATION AND PROCESS PARAMETER GENERATION OF STONE MATERIALS

(71) Applicant: VEEGOO TECHNOLOGY CO., LTD., Foshan (CN)

(72) Inventors: Jianping QIU, Foshan (CN); Zhongyuan LI, Foshan (CN); Yumin CHEN, Foshan (CN); Yuchi QIAN, Foshan (CN)

(21) Appl. No.: 19/021,776

(22) Filed: Jan. 15, 2025

Related U.S. Application Data
(63) Continuation of application No. PCT/CN2024/139888, filed on Dec. 17, 2024.

(30) Foreign Application Priority Data
Mar. 4, 2024 (CN) 202410243812.2

(51) Int. Cl. G06V 10/54; G06T 7/00; G06T 7/40; G06V 10/88

(52) U.S. Cl. CPC G06V 10/54; G06T 7/0004; G06T 7/40; G06V 10/88; G06T 2207/30132

(57) ABSTRACT

A method for texture identification and process parameter generation of stone materials is performed as follows. An image of a to-be-identified stone is obtained.

The image is input into a texture recognition model to generate a texture recognition result and a mask; and a central position along a texture direction of the to-be-identified stone and processing parameters corresponding to a texture of the to-be-identified stone are extracted from the texture recognition result and the mask.

The texture recognition result includes a recognition information of the processing parameters; and the mask is an indicative information of location and shape of individual texture regions in the image.

### CROSS-REFERENCE TO RELATED APPLICATIONS

This application is a continuation of International Patent Application No. PCT/CN2024/139888, filed on Dec. 17, 2024, which claims the benefit of priority from Chinese Patent Application No. 202410243812.2 filed on Mar. 4, 2024. The content of the aforementioned application, including any intervening amendments made thereto, is incorporated herein by reference in its entirety.

### TECHNICAL FIELD

This application relates to image recognition technology, and more particularly to a method and system for texture identification and process parameter generation of stone materials.

### BACKGROUND

With the rapid development of the construction industry and the increasing demand for decoration, stone as a high-quality decorative material, has gained widespread attention and application. However, traditional methods for recognizing stone textures have several shortcomings that limit their effectiveness and efficiency in practical applications.

Traditional manual recognition methods primarily rely on visual observation, requiring workers to spend a significant amount of time and effort to recognize the direction of stone textures. This approach is susceptible to subjective factors and errors, leading to inconsistencies in recognition results among different workers. Moreover, as working hours increase, worker fatigue reduces recognition accuracy, which is particularly problematic in high-intensity production environments.

In addition to the shortcomings of manual recognition, existing automated texture recognition technologies also have certain limitations. These technologies typically depend on image processing and feature extraction algorithms. Although they can achieve partial automation, their accuracy and robustness are relatively low when dealing with complex stone textures. Due to the intricate and diverse nature of stone textures, traditional feature extraction methods struggle to effectively capture both global and local texture information, resulting in imprecise recognition outcomes that fail to meet the requirements of high-precision texture recognition.

Furthermore, existing automated texture recognition technologies generally only provide basic classification and recognition of stone textures. They are unable to offer information on texture direction or relevant processing parameters, such as the adopted tool and pigment composition. This restricts their application in stone processing, as they cannot provide effective decision-making support for subsequent machining, ultimately reducing the efficiency and quality of stone processing.

In summary, current stone texture recognition methods suffer from low efficiency in manual recognition, insufficient accuracy in automated recognition, and an inability to provide further processing parameters. Therefore, a new technical solution is urgently needed to address these challenges.

### SUMMARY

An object of the present application is to provide a method for texture identification and process parameter generation of stone materials that can efficiently and accurately recognize the texture direction of the stones, thereby providing reliable references for subsequent stone processing to meet the construction industry's continuous pursuit of high-quality stone decoration and market demand.

Another object of the present application is to provide a system for texture identification and process parameter generation of stone materials that employs the aforementioned method.

To achieve the above objectives, the present disclosure provides the following technical solutions.

A method for texture identification and process parameter generation of stone materials, comprising:
obtaining an image of a to-be-identified stone;
inputting the image into a texture recognition model to generate a texture recognition result and a mask; and
extracting a central position along a texture direction of the to-be-identified stone and processing parameters corresponding to a texture of the to-be-identified stone from the texture recognition result and the mask;
wherein the texture recognition result comprises a recognition information of the processing parameters; and the mask is an indicative information of location and shape of individual texture regions in the image.

In an embodiment, the texture recognition result further comprises a recognition information of the texture direction.

In an embodiment, the texture recognition model is established through steps of:
collecting a plurality of stone texture sample images; and
pre-processing the plurality of stone texture sample images through steps of:
   annotating the plurality of stone texture sample images to obtain a plurality of annotated images and a label information of each of the plurality of annotated images; wherein each of the plurality of annotated images comprises a texture bounding box and a texture direction label, and the label information comprises production parameters;
   generating an annotated image set and a label information set based on the plurality of annotated images and the label information; and
   generating a training sample group based on the annotated image set and the label information set;
   establishing a You Only Look Once v8 (YOLOv8) network model, and training the YOLOv8 network model based on the training sample group to obtain a trained model; and
   testing the trained model to obtain the texture recognition model.

In an embodiment, the recognition information of the processing parameters comprises a cutting tool information and a pigment information; and the production parameters comprise the cutting tool information and the pigment information.

In an embodiment, the step of testing the trained model to obtain the texture recognition model comprises:
generating a test sample group based on the annotated image set and the label information set;
testing the trained model based on the test sample group to generate a testing result;
tuning the trained model based on the testing result;
repeating testing and tuning steps until the testing result meets a preset condition, and determining a tuned model as the texture recognition model; wherein the preset condition is met in a case that a loss value calculated by a loss function of the trained model decreases to be below a specific threshold.

In an embodiment, the step of training the YOLOv8 network model based on the training sample group to obtain the trained model comprises:
creating a Python 3.8 virtual environment and installing PyTorch, torchvision, and ultralytics under the Python 3.8 virtual environment;
setting hyperparameters of the YOLOv8 network model, wherein the hyperparameters comprise a learning rate, a batch size, the number of iterations, an optimization algorithm, a confidence threshold and a non-maximum suppression threshold; and
determining an optimal parameter to calculate a positive and negative sample assignment strategy and a loss;
wherein the positive and negative sample assignment strategy refers to selecting top k positive samples with highest weighted scores from a weighted score sequence ranked based on classification and regression; a weighted score is calculated by:

$$t = {s}^{α} \times {u}^{β} ;$$

wherein t represents the weighted score; s represents a predicted score corresponding to an annotated cutting tool category; and u represents an intersection-over-union between a predicted bounding box and the texture bounding box; α and β are weight hyperparameters; and s and u are multiplied to measure an alignment degree between the predicted bounding box and the texture bounding box;
wherein the loss refers to a binary cross-entropy loss calculated by:

$$L = [ y \times log ( \hat{y} + ( 1 - y ) \times log ( 1 - \hat{y} ) ] ;$$

wherein L represents the loss; y represents an actual label; and ŷ represents a predicted label.

In an embodiment, before the step of annotating the plurality of stone texture sample images to obtain the plurality of annotated images and the label information of each of the plurality of annotated images comprises:
performing image enhancement and image denoising on the plurality of stone texture sample images.

In an embodiment, the step of extracting the central position along the texture direction of the to-be-identified stone from the texture recognition result and the mask comprises:
scanning, by a computer numerical control (CNC) texture machine, the mask row by row at pixel level; and for each row, identifying pixels where the texture is present; and
identifying a midpoint of the pixels for each row as the central position.

In an embodiment, the plurality of stone texture sample images comprise images of sample stones with varying types, varying specifications and varying texture features.

A system for texture identification and process parameter generation of stone materials, comprising:
an acquisition module;
an identification module; and
an extraction module;
wherein the acquisition module is configured for obtaining an image of a to-be-identified stone;
the identification module is configured for equipping with a texture recognition model; wherein the texture recognition model is configured for generating a texture recognition result and a mask; the texture recognition result comprises a recognition information of the processing parameters; and the mask is an indicative information of location and shape of individual texture regions in the image; and
the extraction module is configured for extracting a central position along a texture direction of the to-be-identified stone and processing parameters corresponding to a texture of the to-be-identified stone.

The method and system for texture identification and process parameter generation of stone materials provided herein has the following advantages. Based on the texture recognition model, texture recognition results and masks are generated. By scanning the image of the to-be-identified stone only once, the position, shape, and direction of each texture in the image, as well as the corresponding processing parameters are accurately identified. This approach not only avoids the errors associated with the manual visual inspection, improving the accuracy and precision of stone texture recognition, but also identifies the processing parameters for each texture as reliable references for subsequent stone processing, meeting the construction industry's growing demand for high-quality stone decoration and market needs.

### BRIEF DESCRIPTION OF THE DRAWINGS

FIG. 1 is a flowchart of the method for texture identification and process parameter generation of stone materials according to an embodiment of the present disclosure; and

FIG. 2 schematically illustrates the results of the system for texture identification and process parameter generation of stone materials according to an embodiment of the present disclosure.

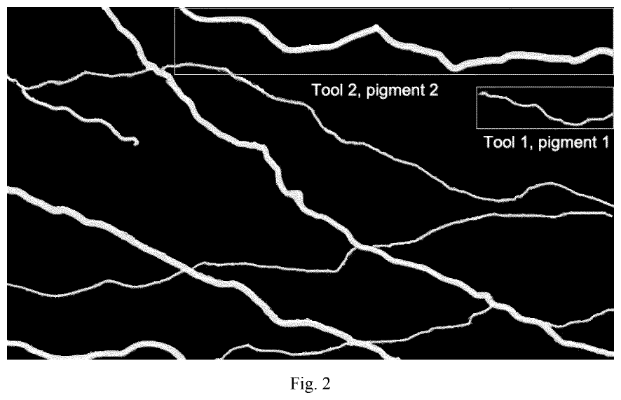

### DETAILED DESCRIPTION OF EMBODIMENTS

The present disclosure has been described in detail above with reference to accompanying drawings and embodiments.

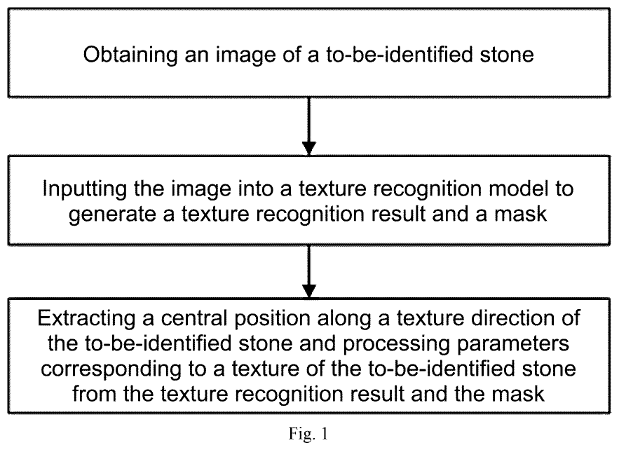

As shown in FIG. 1, a method for texture identification and process parameter generation of stone materials provided herein includes the following steps.

An image of a to-be-identified stone is obtained, the image is input into a texture recognition model to generate a texture recognition result and a mask, and a central position along a texture direction of the to-be-identified stone and processing parameters corresponding to a texture of the to-be-identified stone are extracted from the texture recognition result and the mask.

The texture recognition result includes a recognition information of the processing parameters, and the mask is an indicative information of location and shape of individual texture regions in the image.

Existing automated texture recognition technologies generally only provide basic classification and recognition of the stone textures. They are unable to offer information on texture direction or relevant processing parameters, such as the adopted tool and pigment composition. This restricts their application in stone processing, as they cannot provide effective decision-making support for subsequent machining, ultimately reducing the efficiency and quality of stone processing.

Therefore, the present disclosure provides a method for texture identification and process parameter generation of stone materials. Based on the texture recognition model, texture recognition results and masks are generated. By scanning the image of the to-be-identified stone only once, the position, shape, and direction of each texture in the image, as well as the corresponding processing parameters are accurately identified. This approach not only avoids the errors associated with the manual visual inspection, improving the accuracy and precision of stone texture recognition, but also identifies the processing parameters for each texture as reliable references for subsequent stone processing, meeting the construction industry's growing demand for high-quality stone decoration and market needs.

Furthermore, the texture recognition result also includes the recognition information of the texture direction. Specifically, the texture direction is related to the processing technique, that is, it indicates the direction of the cutting tool during processing.

Furthermore, the texture recognition model is obtained through the following steps.

A plurality of stone texture sample images are collected, and the plurality of stone texture sample images are pre-processed through the following sub-steps.

The plurality of the stone texture sample images are annotated to obtain a plurality of annotated images and a label information of each of the plurality of annotated images. Each of the plurality of annotated images includes a texture bounding box and a texture direction label, and the label information includes a production parameter.

An annotated image set and a label information set are generated based on the plurality of annotated images and the label information.

A training sample group is generated based on the annotated image set and the label information set.

A YOLOv8 network model is established and the YOLOv8 network model is trained based on the training sample group to obtain a trained model.

The trained model is tested to obtain the texture recognition model.

It should be noted that the YOLOv8 network model is the latest series of YOLO based on object detection models, launched by Ultralytics, and it offers the most advanced object detection performance available to date. Compared to traditional texture recognition methods based on feature extraction, YOLOv8, adopting the YOLOv8 network model, which features high efficiency, can complete the stone texture recognition task in a much shorter time, significantly improving both the efficiency of recognition. In the process of stone production and processing, the efficient texture recognition leads to a smoother production line, saving both time and labor costs.

Furthermore, the recognition information of the processing parameters includes a cutting tool information and a pigment information, and the production parameter includes the cutting tool information and the pigment information.

It should be noted that by annotating the plurality of stone texture sample images, annotated images and corresponding label information are obtained. The label information covers various texture directions as well as the corresponding production parameter, namely the cutting tool type name and pigment information, to ensure the generalization capability of the texture recognition model.

Furthermore, the step of testing the trained model to obtain the texture recognition model includes the following sub-steps.

A test sample group is generated based on the annotated image set and the label information set.

The trained model is tested based on the test sample group to generate a testing result.

The trained model is tuned based on the testing result.

The above two steps of testing the trained model and tuning the trained model are repeated to determine the tuned model as the texture recognition model until the tested model meets a preset condition. The preset condition is met in a case that a loss value calculated by a loss function of the trained model decreases to be below a specific threshold.

Furthermore, the step of training the YOLOv8 network model based on the training sample group to obtain the trained model includes the following sub-steps.

A Python 3.8 virtual environment is created and PyTorch, torchvision, and ultralytics are installed under the Python 3.8 virtual environment.

Hyperparameters are set, and the hyperparameters of the YOLOv8 network model include a learning rate, a batch size, the number of iterations, an optimization algorithm, a confidence threshold, and a non-maximum suppression threshold.

An optimal parameter setting is determined to calculate a positive and negative sample assignment strategy and a loss.

The positive and negative sample assignment strategy refers to selecting the top k positive samples with the highest weighted scores from a weighted score sequence ranked based on classification and regression. The weighted score is calculated by:

$$t = {s}^{α} \times {u}^{β} ;$$

In the above formula, t represents the weighted score, s represents a predicted score corresponding to an annotated cutting tool category, and u represents an intersection-over-union between a predicted bounding box and the texture bounding box, α and β are weight hyperparameters, and s and u are multiplied to measure an alignment degree between the predicted bounding box and the texture bounding box;

The loss refers to a binary cross-entropy loss calculated by:

$$L = [ y \times log ( \hat{y} + ( 1 - y ) \times log ( 1 - \hat{y} ) ] ;$$

In the above, formula, L represents the loss, y represents an actual label, and ŷ represents a predicted label.

Furthermore, before the step of annotating the sample images to obtain the plurality of annotated images and the label information of each of the plurality of annotated images includes the following step.

Image enhancement and image denoising are performed on the plurality of stone texture sample images.

To improve the effectiveness of subsequent training of the texture recognition model, pre-processing the aforementioned sample images helps to optimize image quality and enhance the accuracy of later analysis and recognition.

In one embodiment, the information annotation sub-step is performed as follows. The LabelMe software is used to annotate the sample images. Specifically, the image to be annotated is opened in LabelMe, and the texture bounding boxes as well as the texture directions are manually drawn. For each texture, the corresponding cutting tool and pigment identification numbers are entered as category names and recognition markers. The annotation information serves as supervisory signals to guide the learning and optimization of the YOLOv8 network model. After annotation, LabelMe generates a JSON file that contains the annotated image set and the corresponding label information set. The JSON file is then converted to TXT format using the following conversion command:
labelme2coco yourLabelmeJsonFile--output yourOutputDirectory

Where yourLabelmeJsonFile represents the name of the JSON file to be converted, and yourOutputDirectory represents the output directory for the converted file.

It should be noted that LabelMe is a Python-based GUI tool that provides an easy and convenient way to manually annotate images. It can be downloaded and installed from GitHub, or installed in a Python environment using pip install LabelMe.

In one embodiment, the sub-step of image enhancement is performed as follows: Using OpenCV, the cv2.adjustBrightnessContrast( ) function is employed to adjust the brightness or contrast of the sample images; then, the histograms of the red, green and blue channels are scaled individually to remove any color cast in the sample images. This ensures that the sample images span the full 0-255 range, achieving color balance.

In one embodiment, the sub-step of image denoising is performed as follows: Using OpenCV, filtering operations are carried out using the cv2.medianBlur( ) cv2.GaussBlur( ) or cv2.bilateralFilter( ) functions. This removes noise and unnecessary interference from the sample images, making them cleaner and more uniform.

Furthermore, the step of extracting the central position along the texture direction of the to-be-identified stone includes the following sub-steps.

The mask of each of the texture regions is scanned by a computer numerical control (CNC) texture machine row by row at the pixel level. For each row, pixels where the texture is present are identified.

The midpoint of the pixels of each row is connected as the central vector of the texture direction. The central vector of the texture direction of each texture represents the central position along the texture direction.

By performing a pixel-by-pixel row scan on the mask of each texture region and recording the midpoint of the pixels of each row, multiple vectors can be obtained, with each vector representing the central position along the texture direction. These vectors can be collected and organized to form a dataset for further texture direction analysis. In this way, the primary direction of each texture in the image can be determined, which helps in understanding the directional characteristics of the textures and can be further applied in stone processing and design. By analyzing the directional characteristics of varying textures, processing parameters such as cutting direction and the direction of pigment application can be optimized. Additionally, the analysis of texture direction can provide directional information about the texture for product design, achieving a more aesthetically pleasing and realistic effect.

Furthermore, in the training step, the plurality of stone texture sample images include images of the sample textures with varying types, varying specifications and varying texture features.

The system for texture identification and process parameter generation of stone materials provided by this disclosure brings multiple benefits to the stone industry and the field of architectural decoration. The details of the advantages are as follows.

In a specific embodiment, a large number of stone texture sample images with various types, specifications, and texture features are first collected from stone suppliers, stone processing companies and other channels. These sample images include common stone types such as marble and granite, as well as their different texture directions. To increase the diversity and representativeness of the samples, it is preferable to additionally select some stone samples with complex textures and color variations.

A system for texture identification and process parameter generation of stone materials provided herein includes an acquisition module, an identification module and an extraction module.

The acquisition module is configured for obtaining an image of a to-be-identified stone.

The identification module is configured for equipping with a texture recognition model; the texture recognition model is configured for generating a texture recognition result and a mask; the texture recognition result includes a recognition information of the processing parameters; and the mask is an indicative information of location and shape of individual texture regions in the image.

The extraction module is configured for extracting a central position along a texture direction of the to-be-identified stone and processing parameters corresponding to a texture of the to-be-identified stone.

The system for texture identification and process parameter generation of stone materials provided herein has the following benefits.

### Improved Accuracy and Precision

Traditional stone texture recognition methods rely on manual observation, and their results may be affected by subjectivity and errors. In contrast, this method provided herein employs the YOLOv8 network model, which is trained on a large number of sample images of various stone textures. This enables more accurate recognition for different types and the texture direction of the to-be-identified stone, thereby avoiding human error and enhancing the overall accuracy and precision of texture recognition.

### High Efficiency and Fast Recognition

By employing YOLOv8 as the network model, known for its efficiency and speed, this method provided herein can complete stone texture recognition tasks in a much shorter time compared to traditional feature extraction-based methods. This high efficiency significantly speeds up the recognition process, making production lines smoother and saving both time and labor costs during stone production and processing.

### Automated Recommendations and Intelligent Processing

This method provided herein not only recognizes the texture direction of the to-be-identified stone, but also intelligently recommends suitable cutting tool types and pigment information based on the recognition results. This leads to more intelligent subsequent stone processing, where workers no longer need to engage in tedious parameter selection and can directly follow the recommended settings. As a result, processing efficiency and quality are improved, while error rates and material wastage are reduced, thus lowering production costs.

### Enhanced Stone Processing Quality

The texture recognition results provided herein serve as accurate references and guidance for subsequent stone processing. By accurately recognizing the texture direction of the to-be-identified stone and recommending appropriate cutting tools and pigment information, the processing direction can be ensured correct, avoiding unnecessary errors and waste. This helps improve the quality and precision of stone processing, resulting in final products that are more aesthetically pleasing and in line with design requirements.

### Promotion of Technological Upgrades in the Industry

This method provided herein adopts advanced deep learning technology and applies it to the field of stone texture recognition, driving the technological transformation and upgrading of the traditional stone industry. By shifting from manual to automated recognition, the intelligence level of stone processing is enhanced, enabling the traditional industry to better meet the demands of modern production.

In summary, the system for stone texture recognition and processing parameter generation provided herein brings multiple benefits, including improved accuracy, high efficiency, automated recommendations and intelligent processing for the stone industry and the field of architectural decoration. With the application and promotion of this technology, it is expected to advance the development and upgrading of the stone industry and deliver higher-quality stone products for the architectural decoration sector, meeting the ever-growing market demand.

The technical principles of the present disclosure have been described above in conjunction with specific embodiments. These descriptions are provided solely to explain the principles of the disclosure and should not be construed in any way as limiting the scope of the disclosure's protection. Those skilled in the art can still make various changes, modifications and replacements to technical features recited in the above embodiments. It should be understood that those changes, modifications and replacements made without departing from the spirit of the disclosure shall fall within the scope of the disclosure defined by the appended claims.

What is claimed is:

1. A method for texture identification and process parameter generation of stone materials, comprising:
obtaining an image of a to-be-identified stone;
inputting the image into a texture recognition model to generate a texture recognition result and a mask; and
extracting a central position along a texture direction of the to-be-identified stone and processing parameters corresponding to a texture of the to-be-identified stone from the texture recognition result and the mask;
wherein the texture recognition result comprises a recognition information of the processing parameters; and the mask is an indicative information of location and shape of individual texture regions in the image.

2. The method of claim 1, wherein the texture recognition result further comprises a recognition information of the texture direction.

3. The method of claim 2, wherein the texture recognition model is established through steps of:
collecting a plurality of stone texture sample images; and
pre-processing the plurality of stone texture sample images through steps of:
annotating the plurality of stone texture sample images to obtain a plurality of annotated images and a label information of each of the plurality of annotated images; wherein each of the plurality of annotated images comprises a texture bounding box and a texture direction label, and the label information comprises production parameters;
generating an annotated image set and a label information set based on the plurality of annotated images and the label information; and
generating a training sample group based on the annotated image set and the label information set;
establishing a You Only Look Once v8 (YOLOv8) network model, and training the YOLOv8 network model based on the training sample group to obtain a trained model; and
testing the trained model to obtain the texture recognition model.

4. The method of claim 3, wherein the recognition information of the processing parameters comprises a cutting tool information and a pigment information; and the production parameters comprise the cutting tool information and the pigment information.

5. The method of claim 3, wherein the step of testing the trained model to obtain the texture recognition model comprises:
generating a test sample group based on the annotated image set and the label information set;
testing the trained model based on the test sample group to generate a testing result;
tuning the trained model based on the testing result;
repeating testing and tuning steps until the testing result meets a preset condition, and determining a tuned model as the texture recognition model; wherein the preset condition is met in a case that a loss value calculated by a loss function of the trained model decreases to be below a specific threshold.

6. The method of claim 5, wherein the step of training the YOLOv8 network model based on the training sample group to obtain the trained model comprises:
creating a Python 3.8 virtual environment and installing PyTorch, torchvision, and ultralytics under the Python 3.8 virtual environment;
setting hyperparameters of the YOLOv8 network model, wherein the hyperparameters comprise a learning rate, a batch size, the number of iterations, an optimization algorithm, a confidence threshold and a non-maximum suppression threshold; and
determining an optimal parameter to calculate a positive and negative sample assignment strategy and a loss;
wherein the positive and negative sample assignment strategy refers to selecting top k positive samples with highest weighted scores from a weighted score sequence ranked based on classification and regression; a weighted score is calculated by:
$$t = {s}^{α} \times {u}^{β} ;$$
wherein t represents the weighted score; s represents a predicted score corresponding to an annotated cutting tool category; and u represents an intersection-over-union between a predicted bounding box and the texture bounding box; α and β are weight hyperparameters; and s and u are multiplied to measure an alignment degree between the predicted bounding box and the texture bounding box;
wherein the loss refers to a binary cross-entropy loss calculated by:
$$L = [ y \times log ( \hat{y} + ( 1 - y ) \times log ( 1 - \hat{y} ) ] ;$$
wherein L represents the loss; y represents an actual label; and ŷ represents a predicted label.

7. The method of claim 3, wherein before the step of annotating the plurality of stone texture sample images to obtain the plurality of annotated images and the label information of each of the plurality of annotated images comprises:
performing image enhancement and image denoising on the plurality of stone texture sample images.

8. The method of claim 1, wherein the step of extracting the central position along the texture direction of the to-be-identified stone comprises:
scanning, by a computer numerical control (CNC) texture machine, the mask row by row at pixel level; and for each row, identifying pixels where the texture is present; and
identifying a midpoint of the pixels for each row as the central position.

9. The method of claim 3, wherein the plurality of stone texture sample images comprise images of sample stones with varying types, varying specifications and varying texture features.

10. A system for texture identification and process parameter generation of stone materials, comprising:
an acquisition module;
an identification module; and
an extraction module;
wherein the acquisition module is configured for obtaining an image of a to-be-identified stone;
the identification module is configured for equipping with a texture recognition model; wherein the texture recognition model is configured for generating a texture recognition result and a mask; the texture recognition result comprises a recognition information of the processing parameters; and the mask is an indicative information of location and shape of individual texture regions in the image; and
the extraction module is configured for extracting a central position along a texture direction of the to-be-identified stone and processing parameters corresponding to a texture of the to-be-identified stone.
